(19) United States
(12) Patent Application Publication
(10) Pub. No.: US 2003/0179240 A1
(43) Pub. Date: Sep. 25, 2003

(54) Systems and methods for managing virtual desktops in a windowing environment

(76) Inventor: Stephen Gest, Fort Collins, CO (US)

Correspondence Address: HEWLETT-PACKARD COMPANY, Intellectual-Property Administration, P.O. Box 272400, Fort Collins, CO, 80527-2400, US

(21) Appl. No.: 10/101,991

(22) Filed: Mar. 20, 2002

(51) Int. Cl. G09G 5/00

(52) U.S. Cl. 345/779; 345/848

(57) ABSTRACT

Systems and methods for managing virtual desktops in a windowing environment are provided. One embodiment of the present invention is a method for managing virtual desktops in a windowing environment. Briefly described, one such method comprises the steps of: receiving a selection of a number of virtual desktops to be supported in a windowing environment; and based on the number of selected virtual desktops, defining a multi-dimensional navigation space to be used as a logical navigation reference for enabling a user to navigate between the virtual desktops, the multi-dimensional navigation space comprising a plurality of related logical states, each of the related logical states corresponding to one of the virtual desktops; receiving a predetermined navigation command, the predetermined navigation command specifying a next logical state in the multi-dimensional navigation space that is associated with a current logical state; and in response to the predetermined navigation command, displaying the virtual desktop corresponding to the next logical state.

### TECHNICAL FIELD

The present invention is generally related to computer systems that support a windowing environment and, more particularly, is related to systems and methods for managing virtual desktops in a windowing environment.

### BACKGROUND OF THE INVENTION

Currently, a variety of computer systems support a graphical user interface (GUI) in a windowing environment. A GUI includes a type of environment that represents programs, files, and options by means of icons, menus, and dialog boxes on a display device. Using a GUI, a user may select and activate these and other options by pointing and clicking with a mouse and/or with a keyboard. A particular item, such as a scroll bar, works the same way to the user in all applications, because the GUI provides standard software routines to handle these elements and report the user's actions (e.g., a mouse click on a particular icon or at a particular location in text, a key press, etc.). An application program, or application, may call these standard software routines rather than attempting to reproduce them from scratch.

A windowing environment includes an operating system or shell that presents a user with specially delineated areas of the screen call “windows.” Windowing environments (e.g., Macintosh Finder operating system, Windows-based operating systems, UNIX-based operating systems, the OS/2 Presentation Manager, etc.) typically allow windows to be resized and/or moved around on the display. Windowing environments typically provide a standard GUI to users, which is commonly based on drop-down menus, windowed regions on the screen, a pointing device (e.g., a mouse), etc.

GUI-based systems, windowing environments, and other computer systems typically employ a desktop to facilitate user efficiency by presenting an environment in which the user may more easily manage computer applications, tasks, taskbars, menus, etc. For example, a user may organize applications into predefined groups based on their function. Each of the applications may be represented by a small image object called an icon, which may be displayed on the desktop. Such systems also enable a user to group applications onto a small graphic toolbar, or taskbar. A user may select a particular application by clicking a portion of the taskbar corresponding to the application. Typically, these systems also enable a user to customize the appearance of the desktop by, for example, selecting a particular background image, fonts, colors, resolution, etc. and by arranging the layout and appearance of icons, taskbars, windows, etc.

In this environment, after an application is launched, the application typically runs in an application window that appears on the desktop. Although these windows may be manipulated, resized, minimized, etc., when more than one application is opened simultaneously, the desktop may assume a cluttered appearance. As the number of applications running, and the number of icons, taskbars, etc., on a desktop increases, the available screen real estate diminishes.

Recent attempts have been made to alleviate this screen real estate issue by creating virtual desktop management systems. Typically, these systems enable a user to define and manage multiple desktops on the same computer system. For example, a virtual desktop management system may enable a user to create one desktop for office-related applications (e.g., word processing, spreadsheet, database, etc.), one desktop for development applications, one desktop for Internet-related applications (e.g., web browser, streaming video, streaming audio, etc.), etc. In order to switch between virtual desktops, existing systems provide an application interface in the form of a taskbar. The taskbar typically provides a plurality of virtual buttons, icons, or some other form of static images, each of which correspond to one of the virtual desktops. In this manner, a user may switch to a particular virtual desktop by selecting the appropriate image object displayed on the taskbar.

Existing virtual desktop management systems, however, have many disadvantages. For instance, existing systems only partially alleviate the screen real estate issues described above because the application interface (i.e., the virtual desktop management application interface) is displayed on each virtual desktop along with a static image for each virtual desktop to be managed. Therefore, as the number of virtual desktops to be managed increases, more and more on-screen real estate is consumed because more and more static images need to be displayed on the application interface. Furthermore, using existing systems, the user has to manipulate the on-screen cursor over the appropriate static image and select one of the corresponding static images displayed on the application interface. Therefore, existing systems do not provide a very user-friendly environment in which to manage virtual desktops.

In addition, existing virtual desktop management systems do not provide a means by which the user is notified of system activity on virtual desktops that are not currently displayed. For instance, suppose a user has created, among others, an “Internet Desktop” in which a web browser is active and an “Office Desktop” in which a business e-mail application is active. Consider the situation in which the “Internet Desktop” is active and the user is browsing the Internet on the web browser application. Existing systems are not capable of notifying the user of activity requiring attention on the e-mail application (e.g., an urgent message has arrived requiring attention) because the application is active on a different virtual desktop.

Thus, there is a need in the industry for systems and methods for managing virtual desktops in a windowing environment.

### SUMMARY OF THE INVENTION

The present invention provides systems and methods for managing virtual desktops in a windowing environment.

One embodiment of the present invention, among others, is a method for managing virtual desktops in a windowing environment. Briefly described, one such method comprises the steps of: receiving a selection of a number of virtual desktops to be supported in a windowing environment; and based on the number of selected virtual desktops, defining a multi-dimensional navigation space to be used as a logical navigation reference for enabling a user to navigate between the virtual desktops, the multi-dimensional navigation space comprising a plurality of related logical states, each of the related logical states corresponding to one of the virtual desktops.

Another embodiment of the present invention, among others, is a computer program embodied in a computer-readable medium for managing virtual desktops in a windowing environment. Briefly described, one such computer program comprises logic configured to: determine a selection of a number of virtual desktops to be supported in a windowing environment; and based on the number of selected virtual desktops, generate a multi-dimensional navigation space to be used as a logical navigation reference for enabling a user to navigate between the virtual desktops the multi-dimensional navigation space comprising a plurality of related logical states, each of the related logical states corresponding to one of the virtual desktops.

Another embodiment of the present invention, among others, is a system for providing multi-dimensional navigation in a virtual desktop environment. Briefly described, one such system comprises: logic configured to provide a virtual desktop windowing environment in a graphical user interface; logic configured to generate, based on a predetermined number of virtual desktops, a multi-dimensional navigation space stored in memory and to be used as a logical navigation reference for enabling a user to navigate between the predetermined number of virtual desktops, the multi-dimensional navigation space comprising a plurality of logically associated states, each of the logically associated states corresponding to one of the predetermined number of virtual desktops; and logic configured to control the manner in which the predetermined number of virtual desktops are displayed by responding to a predetermined navigation command, the predetermined navigation command specifying a next logical state in the multi-dimensional navigation space that is associated with a current logical state.

A further embodiment of the present invention, among others, is a system for managing virtual desktops in a windowing environment. Briefly described, one such system comprises: a means for providing a virtual desktop windowing environment in a graphical user interface; a means for generating, based on a predetermined number of virtual desktops, a multi-dimensional navigation space to be used as a logical navigation reference for enabling a user to navigate between the predetermined number of virtual desktops, the multi-dimensional navigation space comprising a plurality of logically associated states, each of the logically associated states corresponding to one of the predetermined number of virtual desktops; and a means for controlling the manner in which the predetermined number of virtual desktops are displayed in the graphical user interface by responding to a predetermined navigation command, the predetermined navigation command specifying a next logical state in the multi-dimensional navigation space that is associated with a current logical state Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a screen shot of a desktop in a windowing environment, in which a multi-dimensional navigable virtual desktop management system according to the present invention may be implemented.

FIG. 2 is a screen shot of the desktop of FIG. 1 displaying an application window for a computer application.

FIG. 3 is a screen shot of the desktop of FIGS. 1 and 2, in which the application window is maximized.

FIG. 4 is a screen shot of one of the virtual desktops of a prior art virtual desktop management system.

FIG. 5 is a screen shot of another virtual desktop in the prior art virtual desktop management system of FIG. 4.

FIG. 6 is a high-level block diagram of an embodiment of an exemplary computing system, in which an embodiment of a multi-dimensional navigable virtual desktop management system according to the present invention may be implemented.

FIG. 7 is a flow chart illustrating the architecture, operation, and/or functionality of an embodiment of the multi-dimensional navigable virtual desktop management system of FIG. 6.

FIG. 8 illustrates a three-dimensional geometric solid having six faces, which may be used to represent an embodiment of a multi-dimensional navigation space.

FIG. 9 illustrates a three dimensional geometric solid having four faces, which may be used to represent an embodiment of a multi-dimensional navigation space for a multi-dimensional navigable virtual desktop management system according to the present invention.

FIG. 10 illustrates a three-dimensional state diagram having six states, which may be used to represent another embodiment of a multi-dimensional navigation space for a multi-dimensional navigable virtual desktop management system according to the present invention.

FIG. 11 illustrates a three-dimensional state diagram having four states, which may be used to represent an embodiment of a multi-dimensional navigation space for a multi-dimensional navigable virtual desktop management system according to the present invention.

FIG. 12 is a screen shot of one of the virtual desktops of the multi-dimensional navigable virtual desktop management system of FIGS. 6 and 7, which illustrates an embodiment of an exemplary interactive three-dimensional geometric icon adapted to be used by a user to navigate between virtual desktops.

FIG. 13 is a screen shot of another virtual desktop in the multi-dimensional navigable virtual desktop management system of FIGS. 6-8, in which a user has manipulated the interactive three-dimensional geometric icon to switch to the second virtual desktop.

FIG. 14 illustrates a screen shot of another embodiment of a multi-dimensional navigable virtual desktop management system, in which multiple virtual desktops are displayed simultaneously in a three-dimensional representation.

FIG. 15 illustrates the screen shot of FIG. 13, in which the multi-dimensional navigable virtual desktop management system of FIGS. 6-8 is providing a visual notification that the virtual desktop labeled “3” requires attention.

### DETAILED DESCRIPTION

I. Virtual Desktop Windowing Environment/System Overview

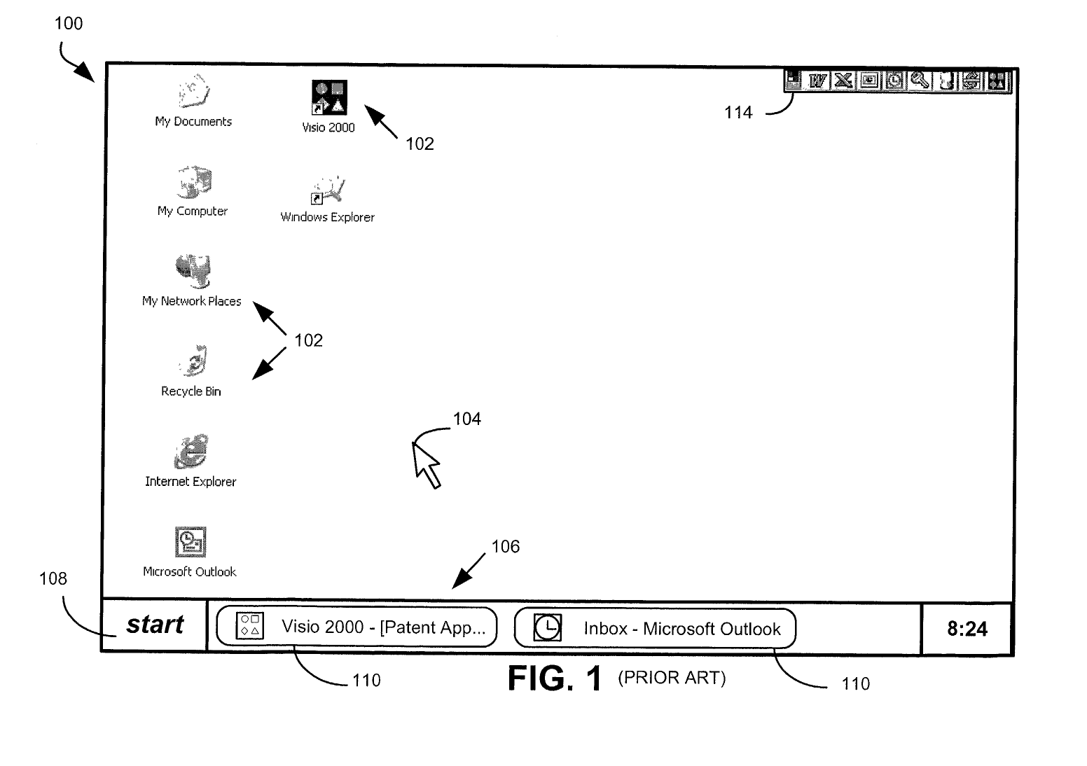

FIG. 1 illustrates a desktop 100 in an exemplary windowing environment of a graphical user interface (GUI) in which a multi-dimensional navigable virtual desktop management system according to the present invention may be implemented. A GUI includes a type of environment that represents programs, files, and options by means of icons, menus, and dialog boxes on a display device. Using a GUI, a user may select and activate these and other options by pointing and clicking with a mouse and/or with a keyboard. A particular item, such as a scroll bar, works the same way to the user in all applications, because the GUI provides standard software routines to handle these elements and report the user's actions (e.g., a mouse click on a particular icon or at a particular location in text, a key press, etc.). Applications may call these standard software routines rather than attempting to reproduce them from scratch.

A windowing environment includes an operating system or shell that presents a user with specially delineated areas of the screen called “windows” in a graphical user interface. Windowing environments (e.g., Macintosh Finder operating system, Windows-based operating systems, UNIX-based operating systems, the OS/2 Presentation Manager, etc.) typically allow windows to be resized and/or moved around on the display. Windowing environments typically provide a standard GUI to users, which is commonly based on drop-down menus, windowed regions on the screen, a pointing device (e.g., a mouse), etc.

GUI-based systems, windowing environments, and other computer systems may employ a desktop 100 to facilitate user efficiency by presenting an environment in which the user may more easily manage computer applications. As illustrated in FIG. 1, a desktop 100 may comprise one or more icons 102, a cursor 104, a system taskbar 106, a start button 108, one or more open applications 110, and a toolbar 114. An icon 102 comprises a small image displayed on a screen to represent an object that can be manipulated by the user via the cursor 104. One of ordinary skill in the art will appreciate that the cursor 104 may be manipulated by a computer keyboard, a mouse, a trackball, other keys, buttons, etc. By serving as visual mnemonics and allowing the user to control certain computer actions without having to remember commands or type them at the keyboard, icons provide a user-friendly experience in a graphical user interface. Start button 108 may be selected by the user via cursor 104 and which controls a main menu for interacting with computer applications and/or other aspects of the computer system.

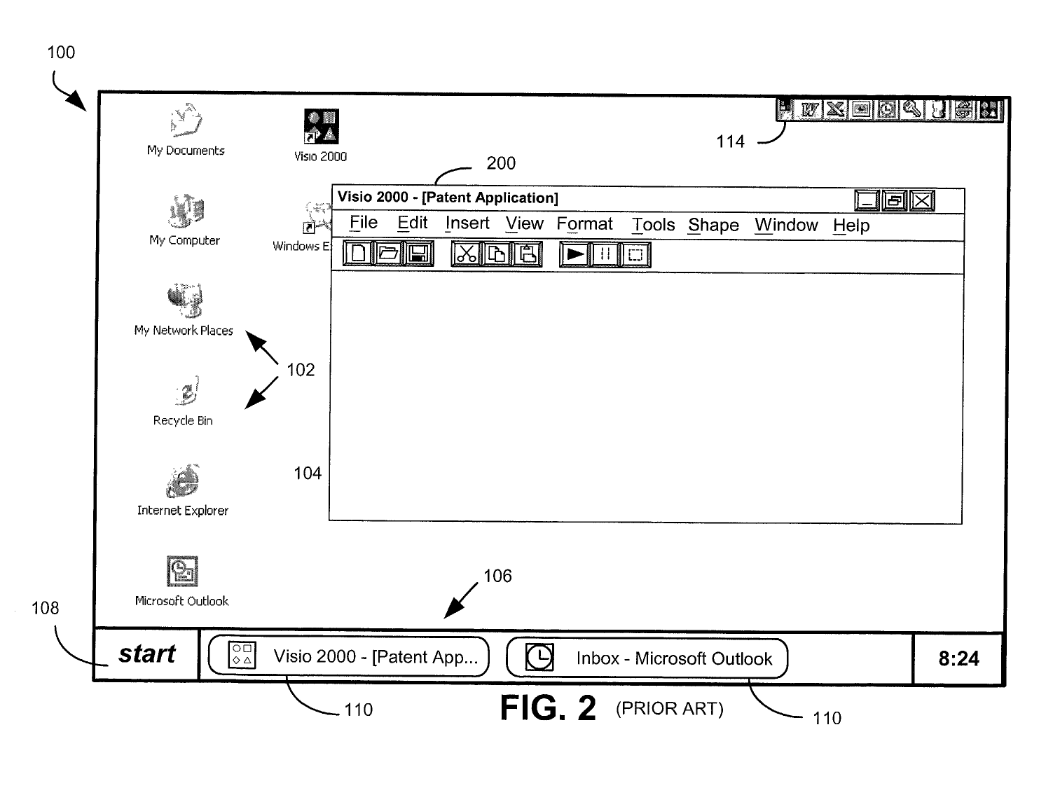

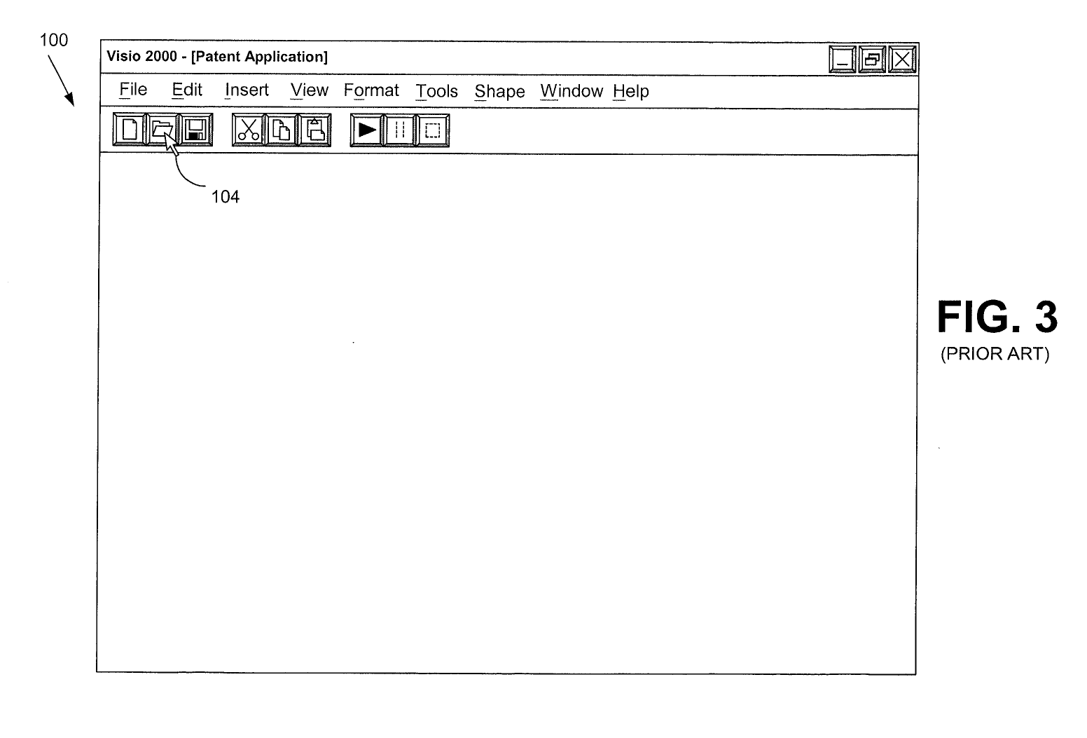

Toolbar 114 is a graphic object that comprises a row, block, column, array, etc. of on-screen buttons or icons. When these buttons or icons are clicked-on with a mouse, macros or certain functions and/or applications are activated. Taskbar 106 comprises a graphic toolbar which may be configured to display buttons corresponding to applications that are currently active within the desktop 100. As illustrated in FIG. 2, a user may open up an application window 200 corresponding to the open application program by selecting the corresponding button on the taskbar 106. As illustrated in FIG. 3, in the desktop environment, application windows 200 may be resized, maximized, minimized, closed, etc. Desktop 100 may be configured such that a user may create, move, edit, and/or delete icons, taskbars, windows, and toolbars, as well as select colors, fonts, background images.

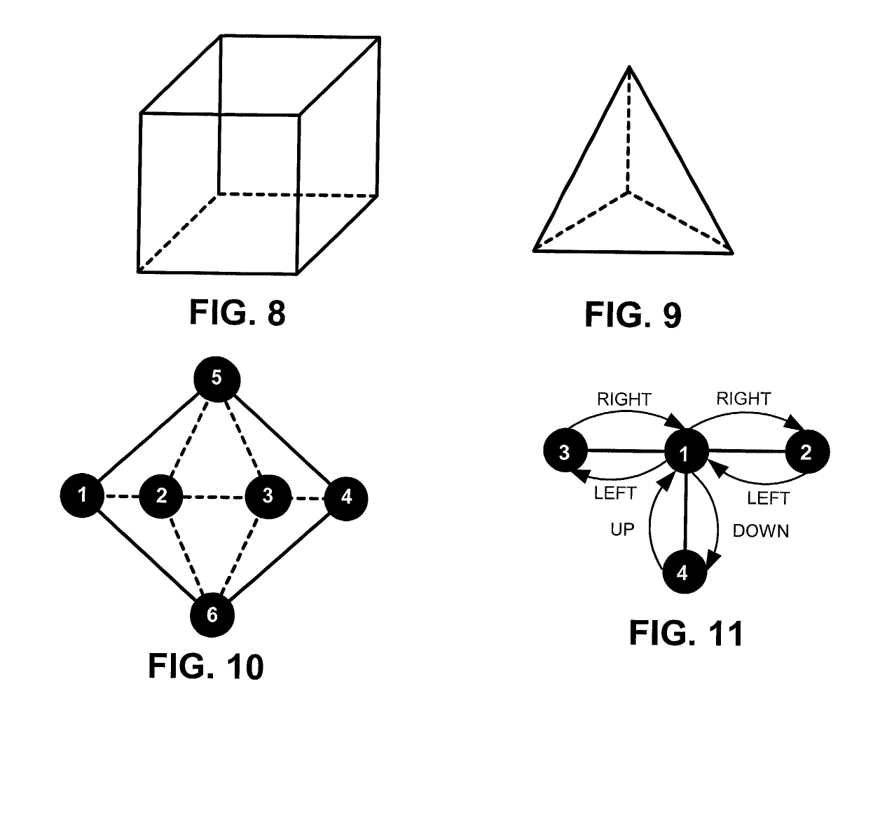

Furthermore, the exemplary desktop 100 of FIGS. 1-3 described above and FIGS. 8 and 9 described below illustrates a desktop 100 as it appears in a Windows-based system developed by Microsoft Corporation. However, one of ordinary skill in the art will appreciate that the terms desktop, windowing environment, and graphical user interface encompass various other types of systems and should be interpreted accordingly.

The operation, functionality, and architecture of a multi-dimensional navigable virtual desktop management system according to the present invention will be described in more detail below. As an introductory matter, the multi-dimensional navigable virtual desktop management system enables a user to manage multiple desktops in a windowing environment in a graphical user interface. In general, the multi-dimensional navigable virtual desktop management system is configured to enable a user to navigate between multiple virtual desktops based on a multi-dimensional navigation space that functions as a logical navigation reference for the user.

As illustrated in Table 1 below, one of a number of embodiments of a multi-dimensional navigation space may comprise a data structure or table that defines a plurality of logically related states, each of which correspond to one of the virtual desktops to be managed. For example, the multi-dimensional navigation space may comprise: (1) a data element that specifies a current logical state that corresponds to a currently-displayed virtual desktop; (2) a data element containing one or more navigation commands that specify the next virtual desktop to be displayed when the associated navigation command is enabled; and (3) a data element that specifies the next logical state that corresponds to the next virtual desktop to be displayed. In this manner, as stated above, the multi-dimensional navigation space defines a logical navigation reference for enabling a user to navigate between virtual desktops based on the navigation commands.

One of ordinary skill in the art will appreciate that the multi-dimensional navigation space may be stored in a memory associated with, and managed by, the multi-dimensional navigable virtual desktop management system. It will be appreciated that, with knowledge of the multi-dimensional space and the corresponding one or more predetermined navigation commands or rules, a user may use this logical navigation reference to switch or navigate between the virtual desktops. In one embodiment, the multi-dimensional navigable virtual desktop management system may be configured without occupying any on-screen real estate. For example, the multi-dimensional navigation space creates an environment in which the user does not necessarily have to interact with a visual display (e.g., a taskbar, or other on-screen interface, etc.). In this embodiment, the navigation commands may comprise commands not associated with the GUI (e.g., keystrokes, etc.), thereby enabling the user to navigate based on the association between the navigation commands and the logical navigation reference defined by the multi-dimensional navigation space. In alternative embodiments, a visual representation of the multi-dimensional navigation space may be displayed on the GUI (e.g., one or more virtual desktops, etc.)

TABLE 1
One Embodiment of a Multi-Dimensional Navigation Space
MULTI-DIMENSIONAL NAVIGATION SPACE

| CURRENTLY- | | |
|---|---|---|
| DISPLAYED VIRTUAL | | NEXT VIRTUAL |
| DESKTOP | NAVIGATION | DESKTOP TO DISPLAY |
| (current logical state) | COMMAND | (next logical state) |
| . . . . . | . . . . . | . . . . . |

By way of example and not by way of limitation, the multi-dimensional navigation space may be represented as a three-dimensional geometric solid, in which each face of the solid represents one of the virtual desktops (e.g., the six faces of a cube may be used to represent six virtual desktops). As a further example, the multi-dimensional navigation space may be represented as a state diagram, in which each state corresponds to one of the virtual desktops. One of ordinary skill in the art will appreciate that the multi-dimensional navigation space may be represented in a variety of other ways, based on any available modeling technique, mathematical theory, etc. Using this logical navigation reference, a user may navigate between the virtual desktops based on one or more predetermined navigation commands. Furthermore, the multi-dimensional navigable virtual desktop management system may display a representation of the multi-dimensional navigation space (e.g., three-dimensional geometric solid, state diagram, etc.) on a virtual desktop to further assist navigation.

As a further example, the three-dimensional geometric solid displayed on the GUI may take the form of an interactive icon, which may be manipulated by a user based on the predetermined navigation commands. In this manner, the user may navigate between virtual desktops by rotating or otherwise manipulating the interactive icon. As stated above, one of ordinary skill in the art will appreciate that the multi-dimensional navigation space need not be displayed on the virtual desktop. One aspect is that the number of virtual desktops to be managed are associated in some manner with the multi-dimensional navigation space. With knowledge of the multi-dimensional space and the corresponding one or more predetermined navigation rules, a user may use this logical reference to switch or navigate between the virtual desktops.

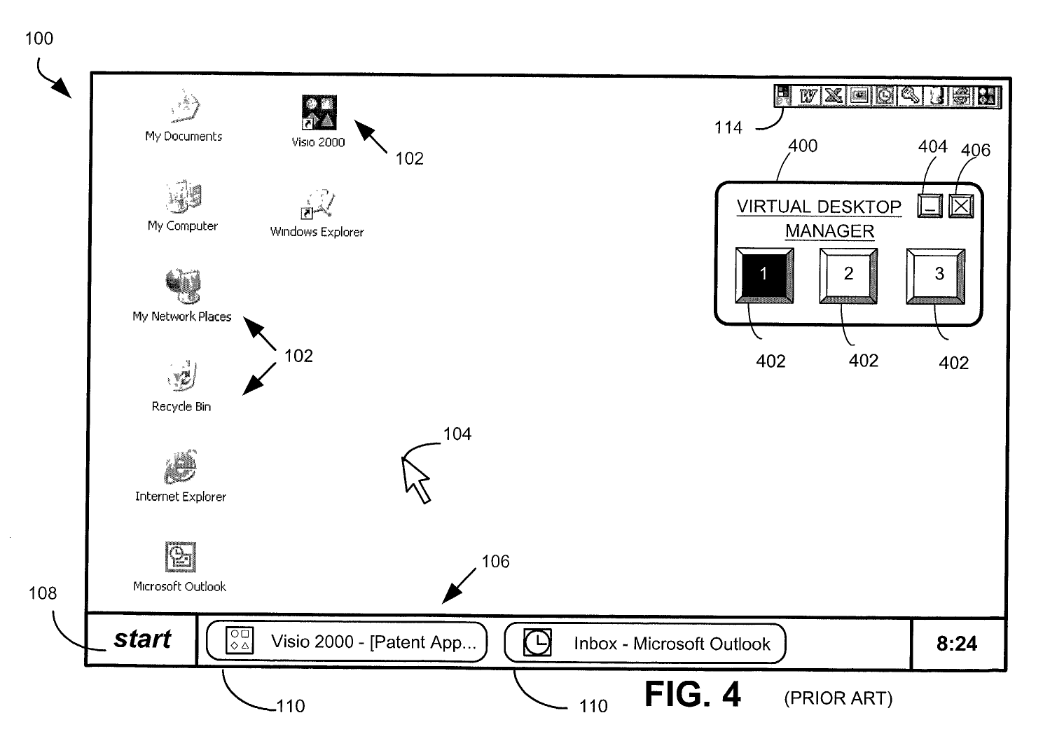

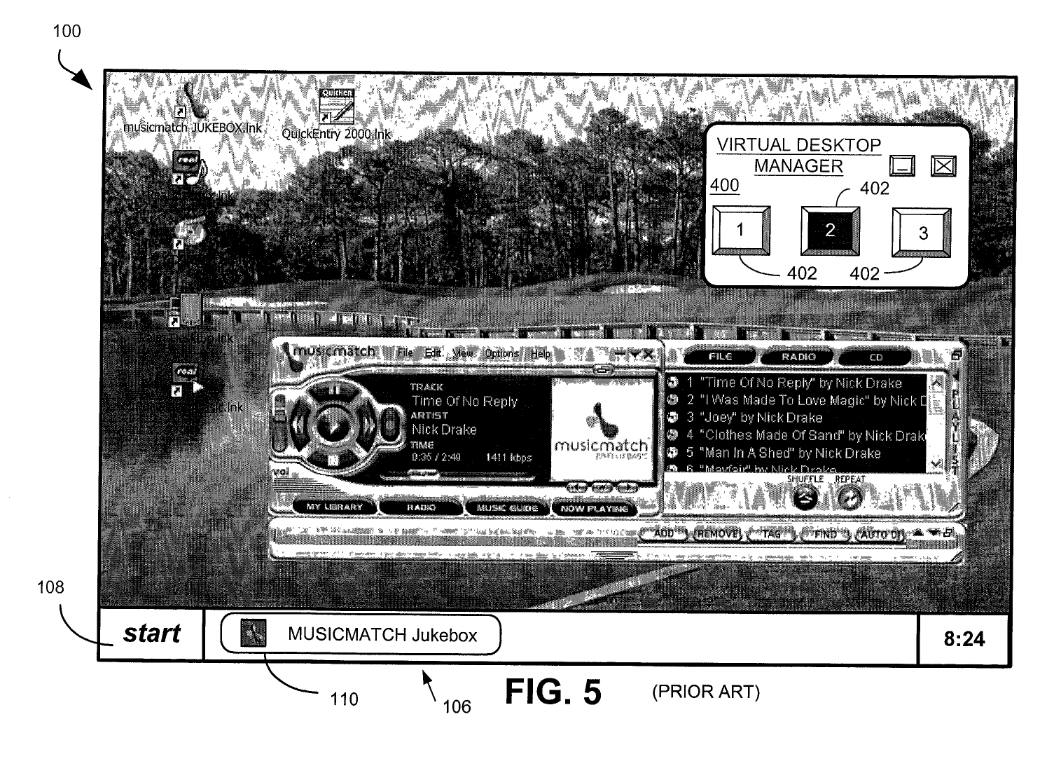

Referring to FIGS. 4 and 5, the architecture, functionality, and/or operation of prior art virtual desktop management systems will be described. As illustrated in FIG. 4, existing systems for managing multiple virtual desktops employ a virtual desktop taskbar 400. The virtual desktop taskbar 400 typically comprises a plurality of virtual buttons 402, each of which correspond to one of the virtual desktops. Virtual buttons 402 comprise an image object, which includes some text or graphic mnemonic that a user associates with the particular virtual desktop. For example, the image objects illustrated in FIG. 4 comprise a series of numbers corresponding to the number of virtual desktops. Virtual desktop taskbar 400 may also comprise a button 404 for minimizing the taskbar and a button 406 for closing the virtual desktop management application.

In operation, prior art virtual desktop management systems enable a user to switch between respective virtual desktops by selecting the corresponding virtual button 402. As illustrated in FIG. 5, when a user selects a particular virtual button 402, the virtual button may be visually distinguished (e.g., by changing the color of the virtual button 402) to show the user which virtual desktop is currently being displayed.

However, as stated above, existing virtual desktop management systems only partially alleviate screen real estate issues because the virtual desktop taskbar 400 is displayed on each virtual desktop along with virtual buttons 402 corresponding to the number of virtual desktops to be manage. Therefore, as the number of virtual desktops to be managed increases, more and more on-screen real estate is consumed because more and more virtual buttons need to be displayed within the two-dimensional real estate on desktop 100. Furthermore, using existing systems, the user has to manipulate the on-screen cursor over the appropriate static image and select one of the corresponding static images displayed on the application interface. Therefore, existing systems do not provide a very user-friendly environment in which to manage virtual desktops.

In addition, existing virtual desktop management systems do not provide a means by which the user is notified of system activity on virtual desktops that are not currently displayed. For instance, suppose a user has created, among others, an “Internet Desktop” in which a web browser is active and an “Office Desktop” in which a business e-mail application is active. Consider the situation in which the “Internet Desktop” is active and the user is browsing the Internet on the web browser application. Existing systems are not capable of notifying the user of activity requiring attention on the e-mail application (e.g., an urgent message has arrived requiring attention) because the application is active on a different virtual desktop.

II. Multi-Dimensional Navigable Virtual Desktop Management System

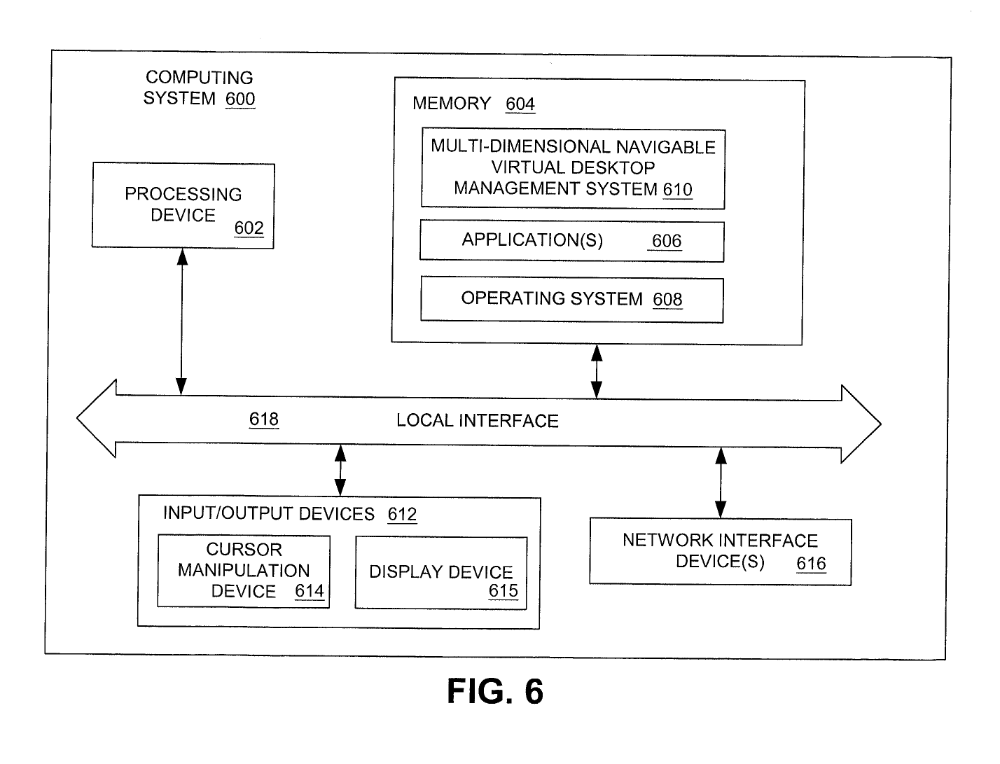

As mentioned above, multi-dimensional navigable virtual desktop management 610 (FIG. 6) enables a user to manage multiple desktops 100 in a windowing environment in a graphical user interface. Multi-dimensional navigable virtual desktop management system 610 enables a user to navigate between multiple virtual desktops 100 based on a multi-dimensional navigation space that functions as a logical navigation reference for the user. The multi-dimensional navigation space defines a plurality of logically related states, each of which correspond to one of the virtual desktops 100 to be managed. One of ordinary skill in the art will appreciate that the multi-dimensional navigation space may be represented in a variety of ways, based on any available discrete modeling technique, discrete mathematical theory, etc. Using this logical navigation reference, a user may switch between the virtual desktops 100 based on one or more predetermined navigation commands.

FIG. 6 is a block diagram of an embodiment of a computing system 600 for implementing multi-dimensional navigable virtual desktop management system 610 according to the present invention. Multi-dimensional navigable virtual desktop management system 610 may be implemented in software, firmware, hardware, or a combination thereof. In the embodiment illustrated in FIG. 6, multi-dimensional navigable virtual desktop management system 610 is implemented in software, as an executable program, which is executed by a processing device 602. Generally, in terms of hardware architecture, as shown in FIG. 6, system 600 comprises a processing device 602, memory 604, one or more network interface devices 616, and one or more input and/or output (I/O) devices 612 interconnected via a local interface 618. System 600 may further comprise additional components not illustrated in FIG. 6.

Referring again to FIG. 6, the various components of system 600 will be described. Local interface 618 may be, for example but not limited to, one or more buses or other wired or wireless connections. The local interface 618 may have additional elements, which are omitted for simplicity, such as controllers, buffers (caches), drivers, repeaters, and receivers, to enable communications. Furthermore, the local interface 618 may include address, control, and/or data connections to enable appropriate communications among the aforementioned components.

Processing device 602 is a hardware device for executing software, particularly that stored in memory 604. Processing device 602 may be any custom-made or commercially-available processor, a central processing unit (CPU), an auxiliary processor among several processors associated with system 600, a semiconductor based microprocessor (in the form of a microchip or chip set), a macroprocessor, or generally any device for executing software instructions.

As illustrated in FIG. 6, memory 604 may comprise an operating system 608, one or more applications 606, and multi-dimensional navigable virtual desktop management system 610. The architecture, operation, and/or functionality of multi-dimensional navigable virtual desktop management system 610 will be described in detail below. Memory 604 may include any one or combination of volatile memory elements (e.g., random access memory (RAM, such as DRAM, SRAM, SDRAM, etc.)) and nonvolatile memory elements (e.g., ROM, hard drive, tape, CDROM, etc.). Memory 604 may incorporate electronic, magnetic, optical, and/or other types of storage media. Furthermore, memory 604 may have a distributed architecture, in which various components are situated remote from one another, but can be accessed by processing device 602.

The software in memory 604 may include one or more separate programs, each of which comprises executable instructions for implementing logical functions. In the example of FIG. 6, the software in memory 604 includes multi-dimensional navigable virtual desktop management system 610 according to the present invention. Memory 604 may further comprise a suitable operating system 608 that controls the execution of other computer programs, such as one or more applications 606 and multi-dimensional navigable virtual desktop management system 610, and provides scheduling, input-output control, file and data management, memory management, and communication control and related services.

Multi-dimensional navigable virtual desktop management system 610 may be a source program, executable program (object code), script, or any other entity comprising a set of instructions to be performed. When implemented as a source program, then the program needs to be translated via a compiler, assembler, interpreter, or the like, which may or may not be included within the memory 604, so as to operate properly in connection with operating system 608. Furthermore, multi-dimensional navigable virtual desktop management system 610 maybe written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

Network interface device(s) 616 may be any device configured to facilitate communication between system 600 and a communication network, such as a public or private packet-switched or other data network including the Internet, a circuit switched network, such as the public switched telephone network, a wireless network, an optical network, or any other desired communications infrastructure.

Input/output devices 612 may comprise any device configured to communicate with local interface 618. One of ordinary skill in the art will appreciate that, depending on the configuration of system 600, input/output devices 612 may include any of the following, or other, devices: a keyboard, a mouse, display device, such a computer monitor, a serial port, a parallel port, a printer, speakers, a microphone, etc.

As illustrated in FIG. 6, system 600 may include a cursor manipulation device 614 and a display device 615. As described in detail below, multi-dimensional navigable virtual desktop management system 610 works in cooperation with a windowing environment in a graphical user. Accordingly, the user may interact with multi-dimensional navigable virtual desktop management system 610 via display device 615 and cursor manipulation device 614. Thus, one of ordinary skill in the art will appreciate that display device 615 may comprise any of the following (or other) types of devices configured to support the graphical user interface: a computer monitor, a liquid crystal display (LCD), a plasma-based display, an LED-based display, a touch-sensitive screen, such as those implemented in portable computing devices (e.g., a personal digital assistant (PDA)), and any other known or future display device, regardless of the underlying display technology. Furthermore, cursor manipulation device 614 may comprise any input device configured to cooperate with an application 606, operating system 608, and/or multi-dimensional navigable virtual desktop management system 610 and manipulate a cursor 104 displayed on the display device 615. For example, cursor manipulation device 614 may comprise a mouse, a trackball, a set of navigation keys (e.g., arrow keys), a keyboard, and a joystick stick, to name a few.

During operation of system 600, the processing device 602 is configured to execute logic stored within the memory 604, to communicate data to and from the memory 604, and to generally control operations of the system 600 pursuant to the software. Multi-dimensional navigable virtual desktop management system 610 and operating system 608, in whole or in part, but typically the latter, are read by the processing device 602, perhaps buffered within the processing device 602, and then executed.

In embodiments where multi-dimensional navigable virtual desktop management system 610 is implemented in software, as is shown in FIG. 6, multi-dimensional navigable virtual desktop management system 610 may be stored on any computer-readable medium for use by or in connection with any computer related system or method. In the context of this document, a computer-readable medium may be an electronic, magnetic, optical, or other physical device or means that may contain or store a computer program for use by or in connection with a computer-related system or method. Multi-dimensional navigable virtual desktop management system 610 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In alternative embodiments where multi-dimensional navigable virtual desktop management system 610 is implemented in hardware, multi-dimensional navigable virtual desktop management system 610 may be implemented with any or a combination of the following, or other, technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

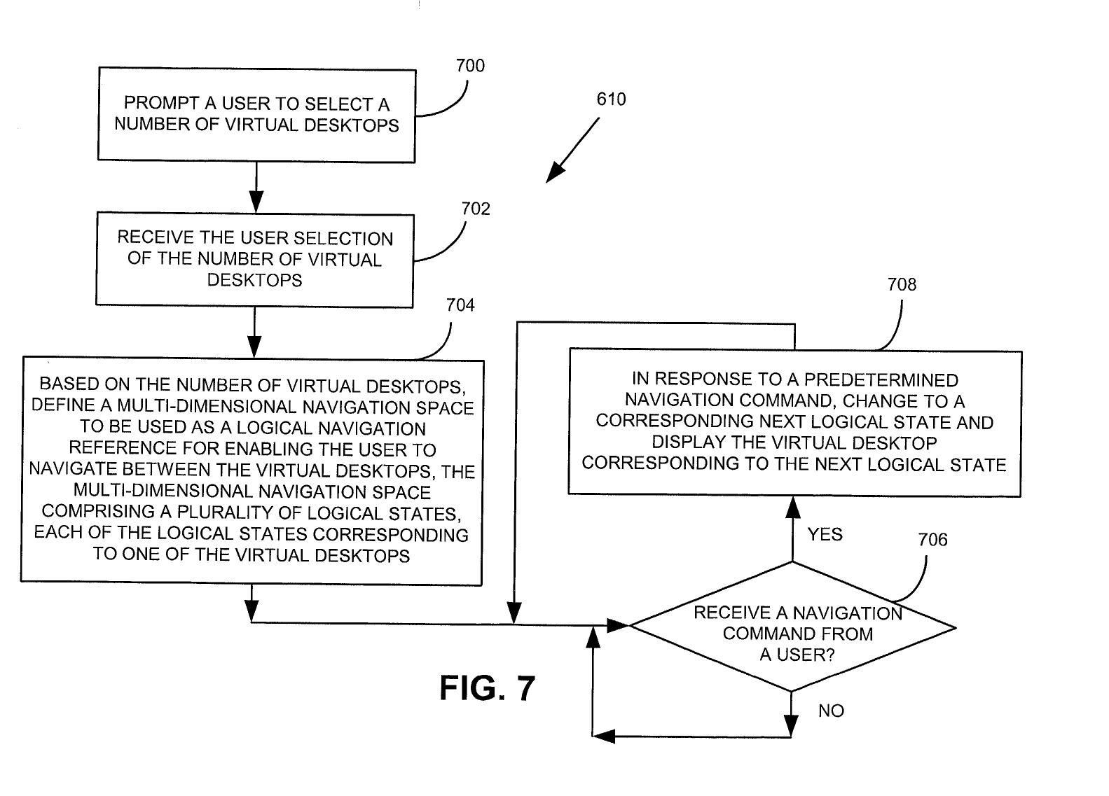

FIG. 7 is a flow chart illustrating the architecture, functionality, and/or operation of an embodiment of multi-dimensional navigable virtual desktop management system 610. At block 700, multi-dimensional navigable virtual desktop management system 610 may prompt a user to select a number of virtual desktops to be generated. At block 702, multi-dimensional navigable virtual desktop management system 610 may receive the user selection of the number of virtual desktops. One of ordinary skill in the art will appreciate that the number of virtual desktops to be generated may be determined in a variety of alternative ways. For example, multi-dimensional navigable virtual desktop management system 610 may automatically generate a predetermined number of virtual desktops 100. In these embodiments, multi-dimensional navigable virtual desktop management system 610 may be configured to subsequently enable the user to edit, delete, create, and/or otherwise modify the configuration of each virtual desktop 100. For instance, multi-dimensional navigable virtual desktop management system 610 may be configured to enable a user to customize what icons 102, taskbars 106, toolbars 114, etc. are displayed in each virtual desktop 100, as well as the arrangement, appearance, etc. of each. Multi-dimensional navigable virtual desktop management system 610 may also be configured to enable a user to customize other aspects of each virtual desktop 100 (e.g., background image, fonts, colors, resolution, open applications, etc.).

Referring again to FIG. 7, at block 704, multi-dimensional navigable virtual desktop management system 610 defines, based on the number of virtual desktops, a multi-dimensional navigation space associated with the virtual desktops 100. In general, the multi-dimensional navigable virtual desktop management system 610 enables a user to navigate between multiple virtual desktops based on the multi-dimensional navigation space and one or more predetermined navigation commands corresponding to the navigation space. As described in more detail below, the predetermined navigation commands may involve any input device associated with the computing system. For example, the predetermined navigation commands may involve any of the following, or other, inputs: keyboard, mouse and/or trackball buttons, cursor manipulation via the mouse and/or trackball, navigation keys, and function keys to name a few. Furthermore, the navigation commands (navigation rules) associated with the inputs may be altered in a variety of ways depending on the configuration of the multi-dimensional navigation space. For example, consider the situation in which the multi-dimensional navigation space is represented as a three-dimensional geometric solid (e.g., each virtual desktop corresponds to a face). In this case, the predetermined navigation commands may comprise keys configured to manipulate the three-dimensional geometric solid.

In a broad sense, the multi-dimensional navigation space is a logical navigation representation of the virtual desktops 100, and therefore, resides in memory 604. The multi-dimensional navigation space may comprise any number of dimensions. By way of example and not by way of limitation, the multi-dimensional navigation space may be represented as a three-dimensional geometric solid, in which each face of the solid represents one of the virtual desktops 100. As illustrated in FIGS. 8 and 9, the multi-dimensional navigation space may be represented as a three-dimensional geometric solid having four or more faces, each of which correspond to one of the virtual desktops 100. For instance, where six virtual desktops are involved a three-dimensional cube may be employed, and where four virtual desktops are involved a tetrahedron may be employed. One of ordinary skill in the art will appreciate that any of a variety of other three-dimensional geometric solids may be employed.

Furthermore, one of ordinary skill in the art will appreciate that the multi-dimensional navigation space may be represented in a variety of other ways, based on any available discrete modeling technique, discrete mathematical theory, etc. For example, as illustrated in FIGS. 10 and 11, the multi-dimensional navigation space may be represented as a state diagram. FIG. 10 illustrates a three-dimensional state diagram having six states, which may be used to represent a multi-dimensional navigation space corresponding to six virtual desktops 100. FIG. 11 illustrates a three-dimensional state diagram having four states, which may be used to a multi-dimensional navigation space corresponding to four virtual desktops 100.

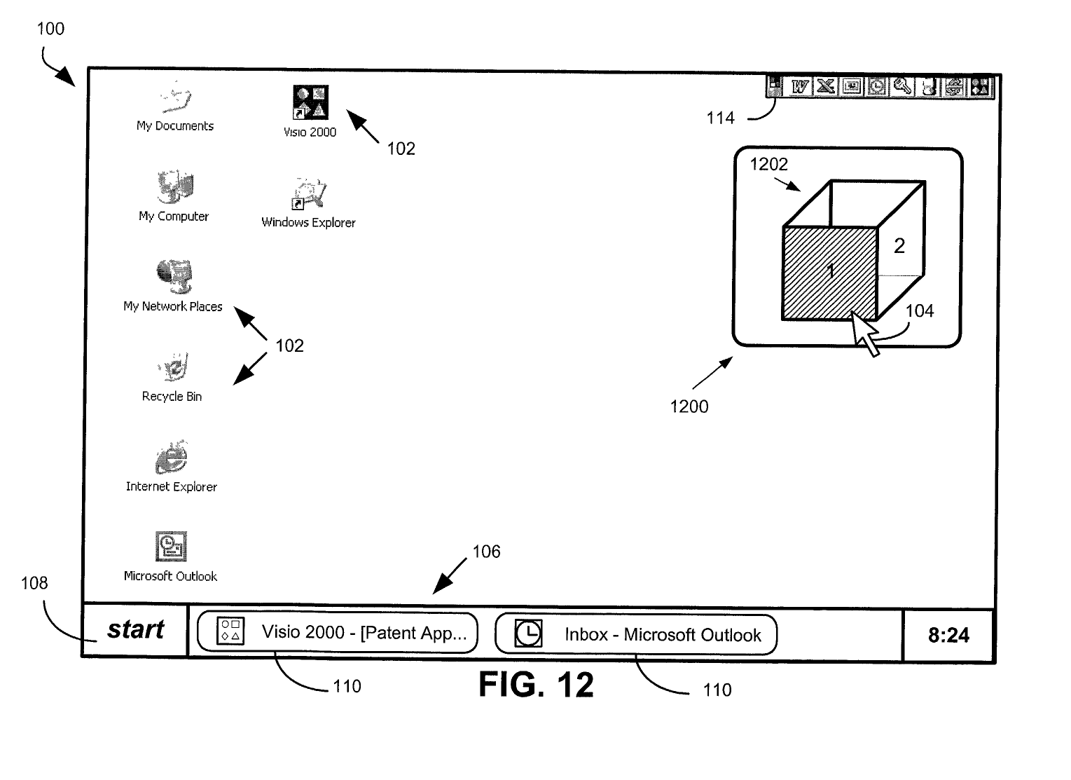

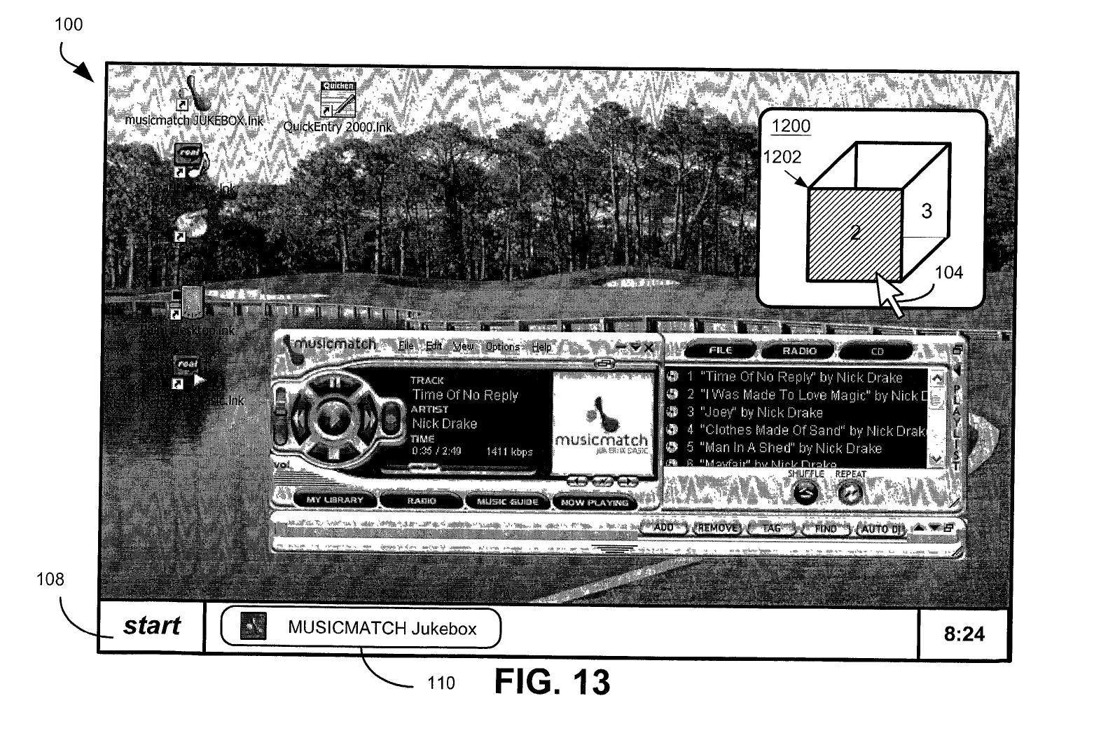

As stated above, the multi-dimensional navigation space defines a logical navigation reference, which may be used by a user to navigate between virtual desktops 100 using one or more predetermined navigation commands. In this regard, multi-dimensional navigable virtual desktop management system 610 may be (although not necessarily) configured to display a visual representation of the multi-dimensional navigation space (e.g., three-dimensional geometric solid, state diagram, etc.) on the virtual desktop to further assist navigation. For example, as illustrated in FIGS. 8 and 9, multi-dimensional navigable virtual desktop management system 610 may be configured to display a representation of the multi-dimensional navigation space on the virtual desktop 100. In the example of FIGS. 12 and 13, a three-dimensional geometric solid is displayed within a portion 1200 of the virtual desktop 100 in the form of an interactive icon 1202. The interactive icon 1202 may be configured such that a user may interact with the icon 1202 by, for example, manipulating the orientation of the three-dimensional geometric solid. Thus, during operation of multi-dimensional navigable virtual desktop management system 610, a user may navigate between multiple virtual desktops by manipulating the interactive icon 1202. As illustrated in FIG. 12, the virtual desktop 100 labeled “1” is currently being displayed. As illustrated in FIG. 13, the user may navigate to the virtual desktop 100 labeled “2” by manipulating the orientation of the icon 1202.

One of ordinary skill in the art will appreciate that the icon 1202 need not be interactive. For example, the visual display of the multi-navigation space on a virtual desktop 100 may be static. In other words, the visual display may not directly interface with the user (i.e., the user may not interface with the icon 1202), but instead act as a true logical reference. In this regard, a static display of the multi-dimensional navigation space merely reminds the user of the association between the virtual desktops 100. Nonetheless, the user may still use the predetermined navigation commands to navigate between the virtual desktops 100.

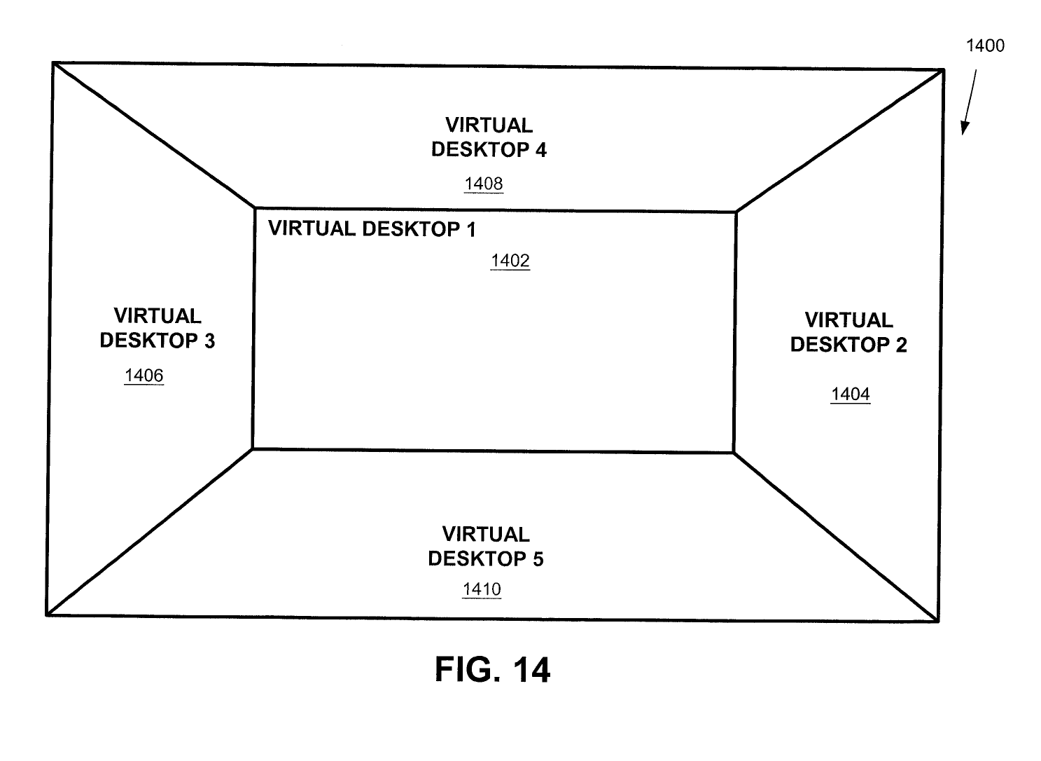

Furthermore, one of ordinary skill in the art will appreciate that the precise visual representation of the multi-dimensional navigation space on the virtual desktop 100 (where applicable) may vary in a variety of ways. In fact, depending on the particular display technology implemented, multi-dimensional navigable virtual desktop management system 610 may employ any type of visual cues. FIG. 14 illustrates an example of a three-dimensional visual cue system, in which multiple virtual desktops are simultaneously displayed within a single on-screen space 1400. In this example, the multi-dimensional navigation space may be represented as a three-dimensional cube, in which each face of the cube represents one of the virtual desktops 100. As illustrated in FIG. 14, the on-screen space 1400 may be configured to resemble the three-dimensional cube, in which: portion 1402 corresponds to “virtual desktop 1;” portion 1404 corresponds to “virtual desktop 2;” portion 1406 corresponds to “virtual desktop 3;” and portion 1408 corresponds to “virtual desktop 4;” portion 1410 corresponds to “virtual desktop 5.” Although not necessary, the remaining face of the cube (not shown) may correspond to a “virtual desktop 6.” In this manner, multi-dimensional navigable virtual desktop management system 610 may be configured such that a user may rotate the cube with one or more predetermined navigation commands.

As stated above, multi-dimensional navigable virtual desktop management system 610 does not necessarily have to be configured to display a visual representation of the multi-dimensional navigation space. Rather, one aspect is that the number of virtual desktops to be managed are associated in some manner with the multi-dimensional navigation space. Thus, with knowledge of the multi-dimensional navigation space and the corresponding one or more predetermined navigation rules, a user may use this logical reference to switch between the virtual desktops.

Referring again to FIG. 7, after defining the multi-dimensional navigation space, multi-dimensional navigable virtual desktop management system 610 may be configured to enable the user to customize each virtual desktop 100 in any of the ways described above. Once the virtual desktops have been defined and/or customized, at decision block 706, multi-dimensional navigable virtual desktop management system 610 determines whether one of the one or more predetermined navigation commands have been received. As illustrated at block 708, if one of the predetermined navigation commands are received, multi-dimensional navigable virtual desktop management system 610 references the multi-dimensional navigation space and determines, based on the predetermined navigation command, which virtual desktop 100 is to be displayed. After displaying the appropriate virtual desktop 100, multi-dimensional navigable virtual desktop management system 610 may continue to manage the virtual desktops 100 by returning to decision block 706.

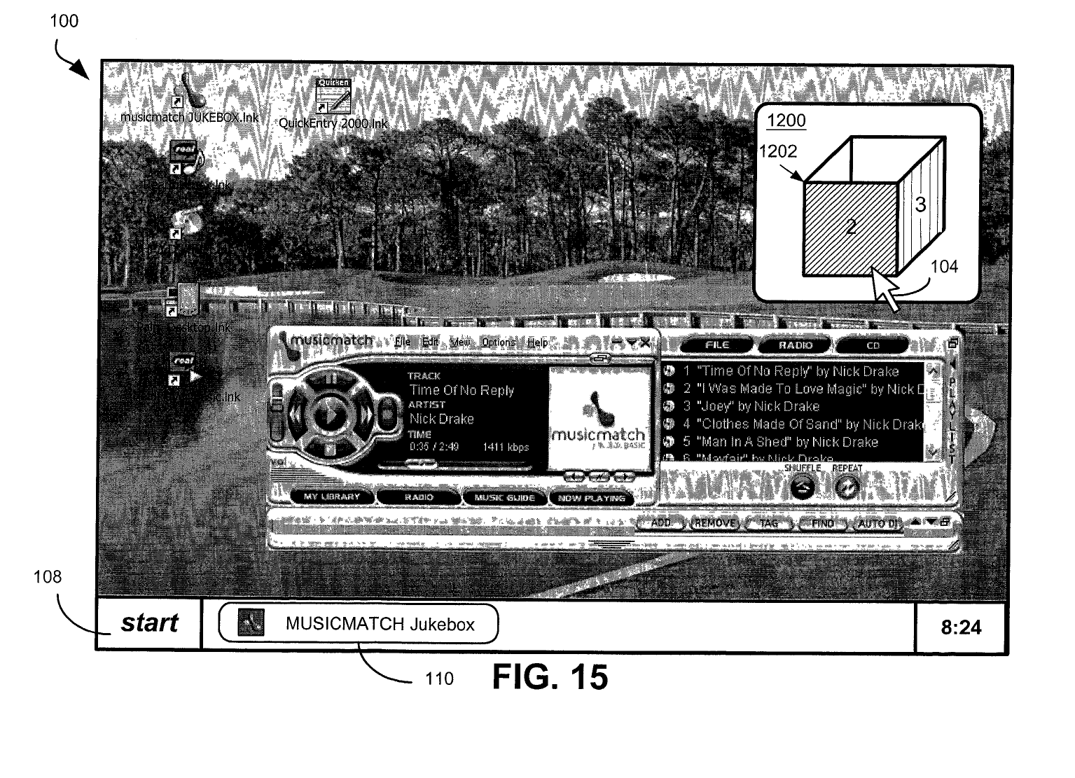

As mentioned above, multi-dimensional navigable virtual desktop management system 610 may be further configured with a means for providing notification to the user of system activity occurring on one of the virtual desktops 100 that is not currently displayed. One of ordinary skill in the art will appreciate that this notification may be provided in a variety of ways. For example, multi-dimensional navigable virtual desktop management system 610 may implement additional visual cues to notify the user of the system activity on other virtual desktops. Furthermore, in embodiments where multiple virtual desktops 100 are displayed simultaneously, multi-dimensional navigable virtual desktop management system 610 may be configured to provide notification of system activity requiring attention on any of the displayed virtual desktops 100 or any other virtual desktops 100 that are not displayed. FIG. 15 illustrates one of many possible embodiments for providing a visual cue that a particular virtual desktop 100, which is not currently displayed, requires attention. In the embodiment illustrated in FIG. 15, the virtual desktop labeled “2” is currently active. However, multi-dimensional navigable virtual desktop management system 610 may determine when some system activity on another virtual desktop requires attention. In the example of FIG. 15, multi-dimensional navigable virtual desktop management system 610 has determined that some activity on the virtual desktop labeled “3” requires attention. Furthermore, the portion of icon 1202, which corresponds to the virtual desktop labeled “3” has been visually distinguished to provide notification to the user that some system activity on this virtual desktop requires attention. One of ordinary skill in the art will appreciate that various other visual methods may be implemented by multi-dimensional navigable virtual desktop management system 610. Alternatively, multi-dimensional navigable virtual desktop management system 610 may employ an audio notification.

It should be emphasized that the above-described embodiments of multi-dimensional navigable virtual desktop management system 610, particularly, any “described” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and protected by the following claims.

Therefore, having thus described the invention, at least the following is claimed:

1. A method for managing virtual desktops in a windowing environment, the method comprising the steps of:
receiving a selection of a number of virtual desktops to be supported in a windowing environment;
based on the number of selected virtual desktops, defining a multi-dimensional navigation space to be used as a logical navigation reference for enabling a user to navigate between the virtual desktops, the multi-dimensional navigation space comprising a plurality of related logical states, each of the related logical states corresponding to one of the virtual desktops.

2. The method of claim 1, further comprising the steps of:
receiving a predetermined navigation command, the predetermined navigation command specifying a next logical state in the multi-dimensional navigation space that is associated with a current logical state; and
in response to the predetermined navigation command, displaying the virtual desktop corresponding to the next logical state.

3. The method of claim 1, wherein the step of receiving a predetermined navigation command involves detecting a predetermined key stroke on a keyboard.

4. The method of claim 1, wherein the step of receiving a predetermined navigation command involves detecting the manner in which an interactive three-dimensional object is manipulated.

5. The method of claim 4, wherein the interactive three-dimensional object comprises an icon displayed on at least one of the virtual desktops.

6. The method of claim 1, wherein the step of defining a multi-dimensional navigation space further comprises associating each of the virtual desktops with one of the faces of a three-dimensional geometric solid.

7. The method of claim 6, further comprising the step of displaying a three-dimensional representation of a least two of the virtual desktops at the same time.

8. The method of claim 1, further comprising the step of, while displaying the virtual desktop corresponding to the current logical state, providing notification of system activity on at least one of the other virtual desktops.

9. The method of claim 8, wherein the step of providing notification of system activity on at least one of the other virtual desktops further comprises providing a visual cue.

10. A computer program embodied in a computer-readable medium for managing virtual desktops in a windowing environment, the computer program comprising logic configured to:
determine a selection of a number of virtual desktops to be supported in a windowing environment; and
based on the number of selected virtual desktops, generate a multi-dimensional navigation space to be used as a logical navigation reference for enabling a user to navigate between the virtual desktops, the multi-dimensional navigation space comprising a plurality of related logical states, each of the related logical states corresponding to one of the virtual desktops.

11. The computer program of claim 10, further comprising logic configured to:
receive a predetermined navigation command corresponding to the multi-dimensional navigation space from the user, the predetermined navigation command specifying a next logical state in the multi-dimensional navigation space that is associated with a current logical state; and
in response to the predetermined navigation command, display the virtual desktop corresponding to the next logical state.

12. The computer program of claim 10, wherein the logic configured to receive the predetermined navigation command further comprises logic configured to detect a predetermined key stroke on a keyboard.

13. The computer program of claim 10, further comprising logic configured to display an interactive three-dimensional geometric solid corresponding to the multi-dimensional navigation space and wherein the logic configured to receive the predetermined navigation command further comprises logic configured to detect the manner in which the interactive three-dimensional geometric solid is manipulated.

14. The computer program of claim 13, wherein the interactive three-dimensional geometric solid comprises an icon displayed on at least one of the virtual desktops.

15. The computer program of claim 10, wherein the multi-dimensional navigation space comprises a three-dimensional geometric solid and further comprising logic configured to associate each of the virtual desktops with one of the faces of the three-dimensional geometric solid.

16. The computer program of claim 15, further comprising logic configured to display at least two of the virtual desktops at the same time in a three-dimensional representation.

17. The computer program of claim 10, further comprising logic configured to provide notification to the user of system activity occurring on one of the virtual desktops that is not currently displayed.

18. The computer program of claim 17, wherein the logic configured to provide notification further comprises logic configured to provide an audio cue.

19. A system for providing multi-dimensional navigation in a virtual desktop environment, the system comprising:
logic configured to provide a virtual desktop windowing environment in a graphical user interface;
logic configured to generate, based on a predetermined number of virtual desktops, a multi-dimensional navigation space stored in memory and to be used as a logical navigation reference for enabling a user to navigate between the predetermined number of virtual desktops, the multi-dimensional navigation space comprising a plurality of logically associated states, each of the logically associated states corresponding to one of the predetermined number of virtual desktops; and
logic configured to control the manner in which the predetermined number of virtual desktops are displayed by responding to a predetermined navigation command, the predetermined navigation command specifying a next logical state in the multi-dimensional navigation space that is associated with a current logical state.

20. The system of claim 19, wherein the logic configured to control the manner in which the predetermined number of virtual desktops are displayed further comprises logic configured to detect a predetermined key stroke on a keyboard.

21. The system of claim 19, further comprising logic configured to display an interactive three-dimensional geometric solid corresponding to the multi-dimensional navigation space and wherein the logic configured to control the manner in which the predetermined number of virtual desktops are displayed further comprises logic configured to detect the manner in which the interactive three-dimensional geometric solid is manipulated.

22. The system of claim 21, wherein the interactive three-dimensional geometric solid comprises an icon displayed on at least one of the virtual desktops.

23. The system of claim 19, wherein the multi-dimensional navigation space comprises a three-dimensional geometric solid and further comprising logic configured to associate each of the virtual desktops with one of the faces of the three-dimensional geometric solid.

24. The system of claim 23, further comprising logic configured to display at least two of the virtual desktops at the same time in a three-dimensional representation.

25. The system of claim 19, further comprising logic configured to provide notification to the user of system activity occurring on one of the virtual desktops that is not currently displayed.

26. The system of claim 25, wherein the logic is configured to provide notification further comprises logic configured to provide an audio cue.

27. The system of claim 19, further comprising a processing device and wherein the logic is stored in memory.

28. The system of claim 19, further comprising a display device and a mouse configured to enable the user to interface with the graphical user interface.

29. A system for managing virtual desktops in a windowing environment, the system comprising:
a means for providing a virtual desktop windowing environment in a graphical user interface;
a means for generating, based on a predetermined number of virtual desktops, a multi-dimensional navigation space to be used as a logical navigation reference for enabling a user to navigate between the predetermined number of virtual desktops, the multi-dimensional navigation space comprising a plurality of logically associated states, each of the logically associated states corresponding to one of the predetermined number of virtual desktops; and
a means for controlling the manner in which the predetermined number of virtual desktops are displayed in the graphical user interface by responding to a predetermined navigation command, the predetermined navigation command specifying a next logical state in the multi-dimensional navigation space that is associated with a current logical state.

30. The system of claim 29, further comprising a means for displaying an interactive three-dimensional geometric solid corresponding to the multi-dimensional navigation space in the graphical user interface and wherein the means for controlling the manner in which the predetermined number of virtual desktops are displayed further comprises a means for detecting the manner in which the interactive three-dimensional geometric solid is manipulated via the graphical user interface.

31. The system of claim 30, wherein the interactive three-dimensional geometric solid comprises an icon displayed on at least one of the virtual desktops.

32. The system of claim 29, further comprising a means for providing notification to the user of system activity occurring on one of the virtual desktops that is not currently displayed.
